(19) United States
(12) Patent Application Publication
(10) Pub. No.: US 2015/0090810 A1
(43) Pub. Date: Apr. 2, 2015

(54) THRUST REVERSER HYDRAULIC ACTUATION SYSTEM WITH SERVO SYNCHRONIZATION

(71) Applicant: Spirit AeroSystems, Inc., (US)

(72) Inventors: Michael Kenneth Lallement, Wichita, KS (US); Alan Bruce Croxall, II, Wichita, KS (US); Scott M. King, Wichita, KS (US)

(73) Assignee: Spirit AeroSystems, Inc., Wichita, KS (US)

(21) Appl. No.: 13/764,538

(22) Filed: Feb. 11, 2013

(51) Int. Cl. F02K 1/76; F02K 1/56

(52) U.S. Cl. CPC F02K 1/763; F02K 1/566
USPC 239/265.19

(57) ABSTRACT

A thrust reverser system and method for controlling actuation thereof. The thrust reverser system may have a control system, two thrust reverser doors actuatable between an open position and a closed position, hydraulic actuators attached to and used to actuate each of the thrust reverser doors, servo valves each communicatively coupled with one of the hydraulic actuators to control hydraulic flow to and from the hydraulic actuators, and position sensors mounted on each of the thrust reverser doors to provide signals associated with a position thereof to the control system. The control system may send command signals to the servo valves to independently adjust at least one of hydraulic flow rate, hydraulic pressure, direction, and position of the hydraulic actuators depending on an amount of offset between the signals received from the position sensors.

### BACKGROUND

Various aircrafts use thrust reverser systems to reduce aircraft speed during landing. These thrust reverser systems may include one or more translating or pivoting cowls, often referred to as thrust reverser doors, that redirect engine thrust forward when opened, providing retarding force to the aircraft.

A conventional thrust reverser system includes a plurality of actuators and locks. A status of the locks can be provided to the pilot via various flight deck indications. Some thrust reverser systems also include position sensors to indicate to a pilot if the actuators are stowed or deployed. The thrust reverser system often uses an aircraft's full authority digital engine control (FADEC) to send and receive information to and from the pilot. Specifically, signals from the position sensors and/or lock switches can be provided to the pilot and/or persons or systems via the FADEC to be monitored. Furthermore, signals from the pilot may be provided to the FADEC and used to operate the actuators via the FADEC. In thrust reverser systems using hydraulic actuators, an aircraft hydraulic system may supply hydraulic fluid to the actuators through several different valves. For example, the valves can include an isolation valve which can be turned on or off. The FADEC may send and receive signals to and from the isolation control valve and therefore dictate whether the isolation control valve is on or off.

If the isolation valve is on, it can provide fluid to a directional control valve or directional control unit, which can provide fluid through a stow port to the actuators to cause the actuators to close or stow the thrust reverser doors or can be actuated to alternatively provide fluid through a deploy port to the actuators to cause the actuators to open or deploy the thrust reverser doors. The directional control valve can be controlled via control logic of the aircraft in response to the pilot actuating a thrust reverser throttle. Furthermore, the valves can include a lock valve configured to receive fluid from the isolation valve when the isolation valve is on, and to receive a command signal from control logic of the aircraft in response to the pilot actuating the thrust reverser throttle. The lock valve can actuate the locks to lock or unlock based on a combination of the command signal and whether or not fluid is received from the isolation valve.

When conventional thrust reverser doors open or close, asymmetric aerodynamic loading on the thrust reverser doors can result in binding or undesired frictional forces. A mechanical system of synchronization typically redistributes asymmetric loading between actuators such that uniform movement of the thrust reverser doors is assured. Specifically, acme screw or ball screw actuators can be moved by either rotation of the screw or by application of hydraulic pressure, causing the screw to turn inside the actuator piston. One or more rotary operable flex shafts can be coupled between gear trains coupled to the screw inside each actuator such that actuators on one thrust reverser door must move simultaneously or such that neither can move for locking. Such mechanical systems can add undesired weight and complexity to the thrust reverser system. Furthermore, the valves and control systems described above are discrete (on or off only) and therefore only provide for complete stowing or complete deployment, but do not provide for varying deployment speeds or varying deployment positions (intermediate positions between fully stowed and fully deployed).

Accordingly, there is a need for a thrust reverser system that overcomes the limitations of the prior art.

### SUMMARY

Embodiments of the present invention provide a thrust reverser system having two thrust reverser doors, hydraulic actuators operated by servo valves controlling deployment and stowing of the thrust reverser doors, and control systems configured to cooperatively synchronize each of the actuators using position feedback. Specifically, the thrust reverser system may have a control system, two thrust reverser doors actuatable between an open position and a closed position, hydraulic actuators attached to and used to actuate each of the thrust reverser doors, servo valves each communicatively coupled with one of the hydraulic actuators to control hydraulic flow to and from the hydraulic actuators, and position sensors mounted on each of the thrust reverser doors to provide signals associated with a position thereof to the control system. The control system may send command signals to the servo valves to independently adjust at least one of hydraulic flow rate, hydraulic pressure, direction, and position of the hydraulic actuators depending on an amount of offset between the signals received from the position sensors.

In use, the control system may receive a command to reverse thrust of at least one of the thrust reverser doors and may then send a deploy command to the servo valves. When the servo valves receive the deploy command, they may each provide hydraulic fluid to one of the hydraulic actuators, thereby deploying the thrust reverser doors toward an open or reverse thrust position. Furthermore, the control system may receive signals containing position information from the position sensors mounted at various locations on the thrust reverser doors. Depending on an amount of offset between the signals received from the position sensors, the control system may send command signals to at least one of the servo valves to adjust hydraulic flow rate, hydraulic pressure, direction, and/or position of at least one of the hydraulic actuators, thereby synchronizing the actuation of all of the actuators and both thrust reverser doors.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a thrust reverser system constructed in accordance with a first embodiment of the present invention;

FIG. 2 is a schematic diagram of a thrust reverser system constructed in accordance with a second embodiment of the present invention;

FIG. 3 is a schematic diagram of a thrust reverser system constructed in accordance with a third embodiment of the present invention;

FIG. 4 is a schematic diagram of a thrust reverser system constructed in accordance with a fourth embodiment of the present invention; and

FIG. 5 is a flow chart of a method of deploying and stowing a thrust reverser in accordance with various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

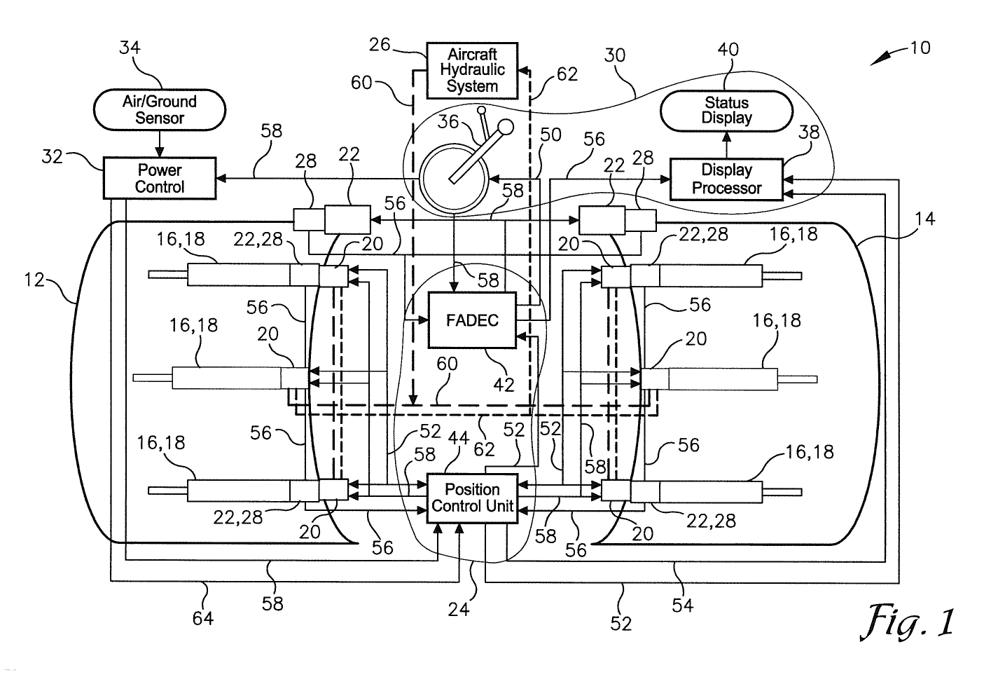

FIGS. 1-4 illustrate a thrust reverser system 10 of an aircraft according to various embodiments of the present invention. The thrust reverser system 10 may comprise a first thrust reverser door 12, a second thrust reverser door 14, and a plurality of actuators 16 configured to actuate the first and second thrust reverser doors 12,14 between a deployed position and a stowed position. Each thrust reverser door 12,14 is configured to be deployed or stowed relative to a nacelle of an aircraft to which it is attached. In the stowed position, the thrust reverser system 10 does not interfere with normal operation of the aircraft nacelle or its engine. However, in the deployed position, the thrust reverser system 10 opens the thrust reverser doors 12,14 and thereby reverses the direction of the thrust from the engine to assist the aircraft in slowing down and/or breaking. The thrust reverser system 10 may further comprise position sensors 18, servo valves 20, locking devices 22, and one or more control systems 24. The position sensors 18, servo valves 20, and locking devices 22 may send and receive various communication, command, fault, and/or status signals to and from the control systems 24 via a network bus, a plurality of discrete communication wires or cables, various wireless communication signals, and/or any means known in the art for transmitting and receiving such signals. The servo valves 20, actuators 16, locking devices 22, and/or some of the control systems 24 may also be fluidly coupled with an aircraft hydraulic system 26, which may provide hydraulic fluid to any valves or hydraulically-operated components described herein.

The thrust reverser doors 12,14 may be moveable, pivotable, and/or translatable cowls covering a plurality of thrust reverser vanes (not shown) or other thrust reversing elements within the nacelle in a closed or stowed position and exposing the thrust reverser vanes or other thrust reversing elements to exhaust from an aircraft engine in an open or deployed position. In the deployed position, the thrust reverser vanes or other thrust reversing elements direct the exhaust from the engine in a generally outward and forward direction to reverse the thrust of the aircraft. In some embodiments of the invention, the thrust reverser doors 12,14 may also be moveable, pivotable, or translatable to an intermediate position at any point between the closed or stowed position and the open or deployed position, thereby providing varying amounts of reverse thrust, as desired for a given application.

The actuators 16 may each be hydraulic actuators having a moveable component and a fixed component. For example, the actuators 16 may be of an acme screw or ball screw design without any of the mechanical gear train or sync shafts required for synchronization in prior art thrust reverser systems. Alternatively, the hydraulic actuators 16 may be of an internally locking dual acting type, without gearing, acme, or ball screw coupling. The hydraulic actuators 16 may be controlled by increasing or decreasing an amount of fluid or gas applied to the movable component, such as via the servo valves 20 described below. The hydraulic actuators 16 may be configured to receive hydraulic fluid from and return hydraulic fluid to the aircraft hydraulic system 26. The fixed component may be fixed to a fixed portion of the nacelle and the moveable component may be fixed to one of the thrust reverser doors 12,14. Actuation of the actuators 16 may actuate or translate the thrust reverser doors 12,14 between the stowed and deployed positions.

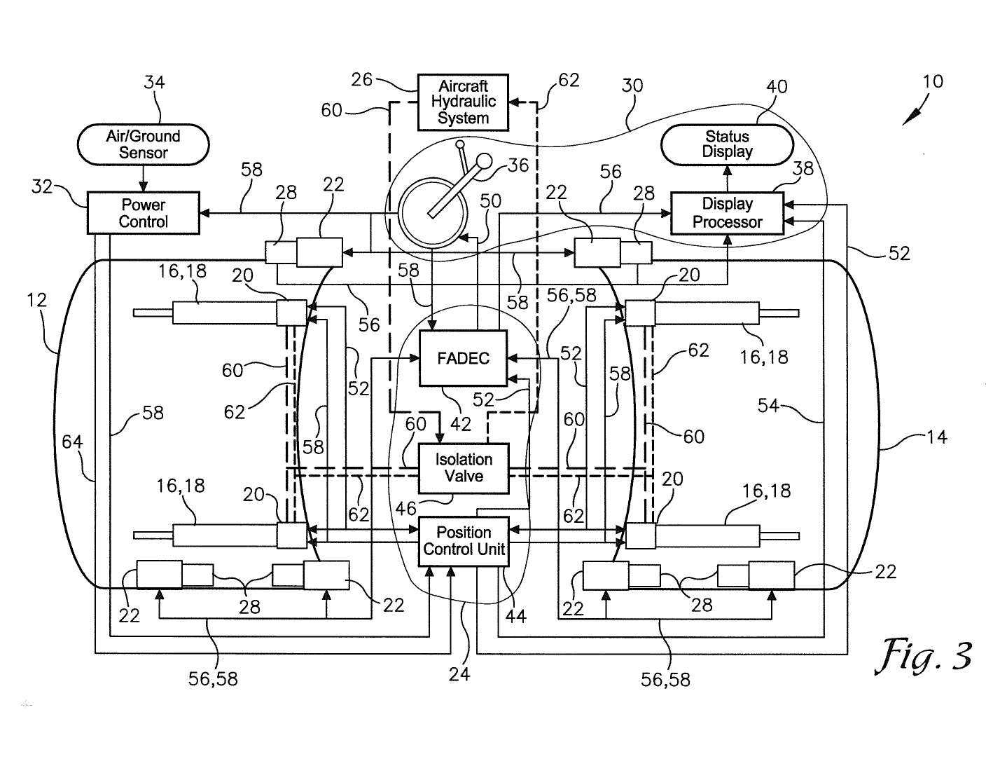

In some embodiments of the invention, there may be three actuators 16 spaced apart from each other on each of the thrust reverser doors 12,14, including a top actuator, a middle actuator, and a bottom actuator. In some embodiments of the invention, as in FIG. 3, the middle actuator positioned between the top and bottom actuators could be omitted, so that each of the thrust reverser doors 12,14 include just the top actuator and the bottom actuator. The quantity of actuators on each of the thrust reverser doors 12,14 may depend on an amount of stability desired or required for a particular thrust reverser system.

In some embodiments of the invention, the actuators 16 may be coupled with and/or comprise at least one of the position sensors 18. For example, as illustrated in FIG. 1, the position sensors 18 may be mounted internally to the actuators 16 such that direct position sensing is coupled to the thrust reverser doors 12,14. Additionally, in some embodiments of the invention, as illustrated in FIG. 1, at least some of the locking devices 22 may be coupled with and/or integral to the actuators 16. For example, as noted above, the hydraulic actuators 16 may be of an internally locking dual acting type, without gearing, acme, or ball screw coupling.

The position sensors 18 may be linear variable differential transformers (LVDT) or other position-determining devices. The position sensors 18 may communicate with at least one of the control systems 24 using electrical output or other types of output, such as wireless communication signals. The position sensors 18 may be internally or externally coupled to the actuators 16 independent of servo valve placement. For example, the position sensors 18 may be integral with the actuators 16, located proximate to one or more of the actuators 16, and/or positioned at one or more locations along the thrust reverser doors 12,14. In some embodiments of the invention, the position sensors 18 on each of the thrust reverser doors 12,14 may comprise a top position sensor located proximate to a hinge beam of the nacelle and a bottom position sensor located proximate to a latch beam of a nacelle. In some embodiments of the invention, an optional one of the position sensors 18 may also be located at or proximate to a midway point between the latch beam and the hinge beam of the nacelle on the thrust reverser door 12,14.

The servo valves 20 may be integrally, physically, and/or functionally coupled with each of the actuators 16 and may be configured to control positions of the actuators 16 to which they are coupled. In some embodiments of the invention, the servo valves 20 may be integrated on the actuators 16 or separately located as needed to accommodate installation space. Each of the servo valves 20 may be configured to receive and/or send signals from and to one of the control systems 24 and thereby regulate hydraulic flow rate, pressure, direction, and/or position of a corresponding one of the actuators 16 to achieve commanded movement thereof based on feedback response to active position sensor measurements. In some embodiments of the invention, the servo valves 20, in cooperation with one or more control systems 24 described below, may be configured to replace directional control valve and/or isolation valve functions of prior art thrust reverser control systems. The servo valves 20 may be configured to provide precision control of the actuators 16, such that the speed of each of the actuators 16 and the position of each of the actuators 16 may be continuously varied. For example, the servo valves 20 may deploy the thrust reverser doors 12,14 to any position between fully stowed and fully deployed as desired by the pilot and/or any of the control systems 24 described herein.

The locking devices 22 may be any position-locking devices known in the art for locking a position of the actuators 16 and/or thrust reverser doors 12,14 in a desired position. For example, the locking devices 22 may be configured to lock the thrust reverser doors12,14 in any of their open, closed, or intermediate positions. The locking devices 22 may be electrically or hydraulically operated and may be coupled between fixed and movable components of each of the thrust reverser doors 12,14. In some embodiments of the invention, at least some of the locking devices 22 may be integral components of the actuators 16, as illustrated in FIG. 1. Status outputs from the locking devices 22 may be provided directly by the locking devices 22 or by lock switches 28 associated with or integral to the locking devices 22. The lock switches 28 may be any devices configured to sense whether an associated one of the locking devices 22 is locked or unlocked and/or to provide status signals to various components of the thrust reverser system 10 indicating statuses of one or more of the locking devices 22. Status outputs from the locking devices 22 may be input into one of the control systems 24 described below such that movement of the thrust reverser doors 12,14 is coordinated with locking and unlocking functions of the locking devices 22.

The control systems 24 may include any number of processors, controllers, integrated circuits, programmable logic devices, or other computing devices and residential or external memory for storing software code, executable instructions, data, threshold values, images, and other information accessible by and/or generated by the control systems 24. The control systems 24 may be communicably coupled with each other, the position sensors 18, the servo valves 20, the locking devices 22, and various other control systems and units of the aircraft via wireless or wired connections, such as via a data bus enabling information to be exchanged between the various components.

The control systems 24 may implement a computer program and/or code segments to perform the functions described herein. The computer program preferably comprises an ordered listing of executable instructions for implementing logical functions in the control systems. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electromagnetic, infrared, or semi-conductor system, apparatus, device or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The memory may be integral with the control systems 24, stand-alone memory, or a combination of both. The memory may include, for example, removable and non-removable memory elements such as RAM, ROM, flash, magnetic, optical, USB memory devices, and/or other conventional memory elements. The memory may store various data associated with the thrust reverser system 10, such as the computer program and code segments mentioned above, or other data for instructing elements of the thrust reverser system 10 to perform the steps described herein. Further, the memory may store various command and control parameters for interpreting and processing the position information received by the position sensors 18. The various data stored within the memory may also be associated with memory locations within one or more databases to facilitate retrieval of the information from the one or more databases.

In some embodiments of the invention, as illustrated in FIGS. 1-4, the control systems 24 may also comprise or be communicably coupled with a user interface 30 or a plurality of user interfaces to allow a pilot to input commands to be received by the thrust reverser system 10. The control systems 24 may also comprise or be communicably coupled with a power control unit 32 of the aircraft, which may receive signals from an air/ground sensor 34 and the user interface 30.

The user interface 30 may permit a user or pilot to operate the thrust reverser system 10 and enables users, third parties, or other devices to share information with the thrust reverser system 10. The user interface 30 may comprise one or more functionable inputs such as buttons, switches, scroll wheels, a touch screen associated with a status display, voice recognition elements such as a microphone, pointing devices such as mice, touchpads, tracking balls, styluses, a camera such as a digital or film still or video camera, combinations thereof, etc. Further, the user interface 30 may comprise wired or wireless data transfer elements such as a removable memory, data transceivers, etc., to enable the user and other devices or parties to remotely interface with the thrust reverser system 10. The user interface 30 may also include a speaker for providing audible instructions and feedback.

As illustrated in FIGS. 1-4, the user interface 30 may include a throttle 36 controlled by a pilot in a cockpit of the aircraft, indicating if reverse thrust should be applied and/or how much reverse thrust should be applied via deployment of the thrust reverser doors 12,14. Furthermore, the user interface 30 may comprise a display processor 38 and/or status display 40 for processing and displaying status information received from the locking devices 22, position sensors 18, control systems 24, or other components of the thrust reverser system 10.

The power control unit 32 of the aircraft may be any power control unit known in the art and may receive reverse thrust commands from the throttle 36 and provide command signals and/or power to any of the control systems 24 noted herein. The power control unit may also receive information from the air/ground sensor 34 or other various aircraft sensors and control systems.

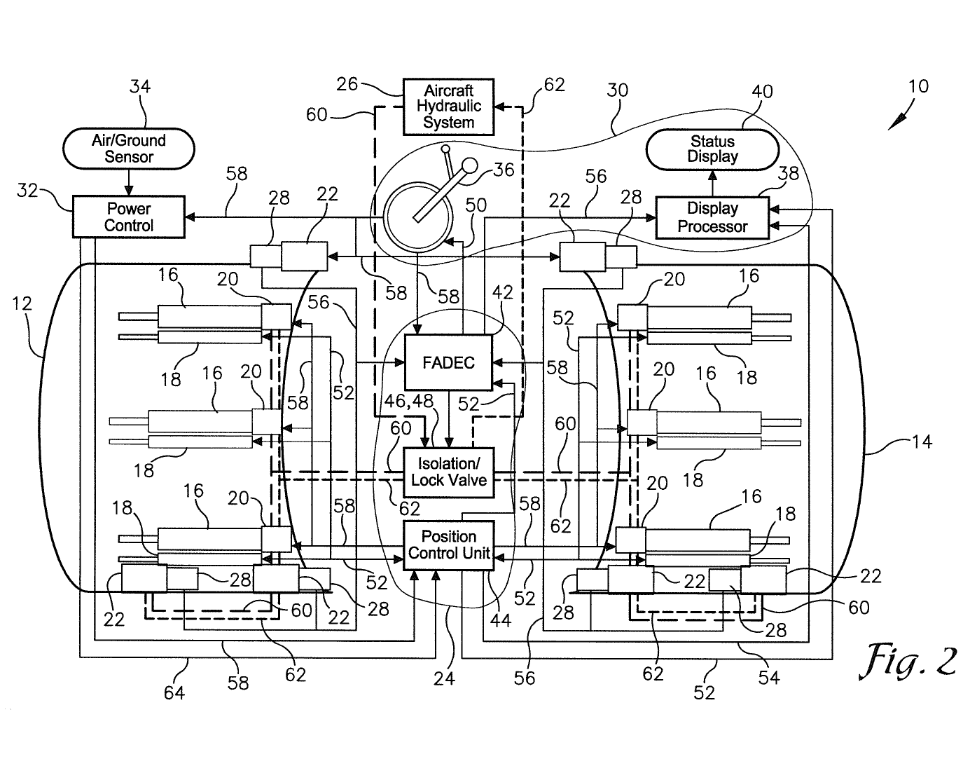

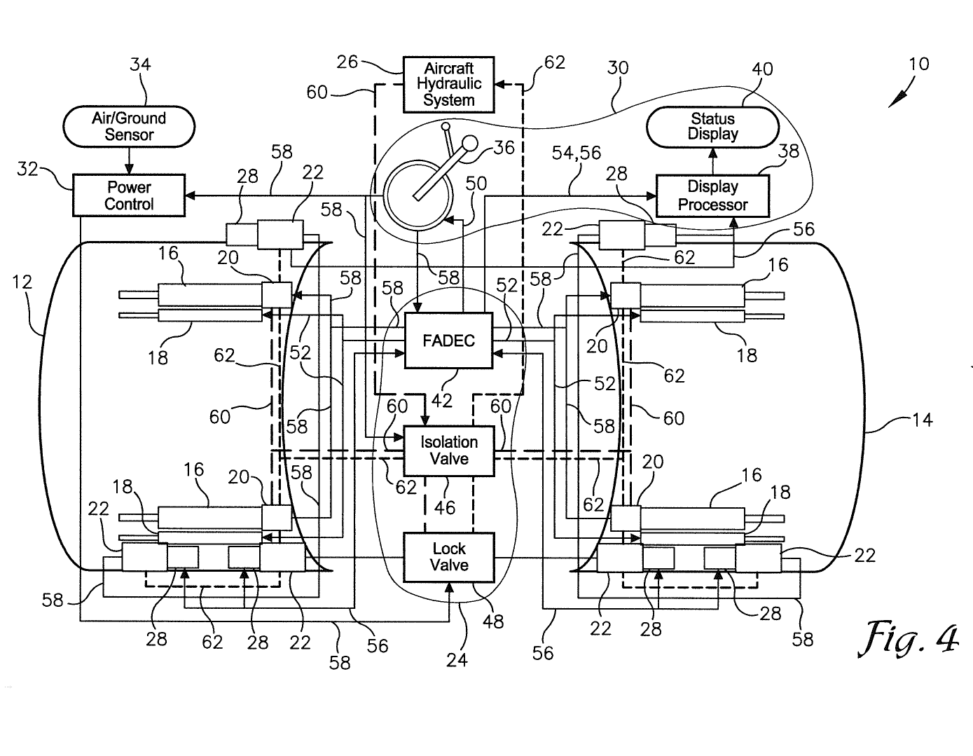

In some embodiments of the invention, the control systems 24 may comprise an aircraft's full authority digital engine control (FADEC) 42, a position control unit 44, an isolation valve 46, and/or a lock valve 48, depending on the type of control redundancy required for a given aircraft and thrust reverser configuration. In some embodiments of the invention, servo valve control may be separate from position signal processing or these processes may be combined into a single control unit. Furthermore, in some embodiments of the invention, position and control functions of the thrust reverser doors 12,14 may be integrated into the FADEC 42 or engine control unit with other control units of the aircraft retaining control of locking functions, as illustrated in FIG. 4. In some embodiments of the invention, the servo valves 20 replace directional control valve functions of the prior art, but still include a separate isolation valve, as in FIGS. 2-4. In other embodiments of the invention, the servo valves 20 may replace both the directional control and isolation valve functions of the prior art, as in FIG. 1.

The FADEC 42 may include one or more processors, logic circuitry, electrical wires, memory, and any combination of hardware and software. The FADEC 42 may receive thrust commands from the throttle 36 controlled by a pilot in a cockpit of the aircraft, indicating if reverse thrust should be applied and/or how much reverse thrust should be applied via deployment of the thrust reverser doors 12,14. The FADEC 42 may also provide tactile feedback to the throttle 36 for the pilot via a throttle interlock signal 50. The throttle 36 may also be configured to send a command signal to control logic and/or the power control unit 32 indicating that reverse thrust has been selected. Furthermore, the power control unit 32 may be configured to provide both power and/or a reverse thrust command signal to the position control unit 44, isolation valve 46, or lock valve 48, thereby providing redundancy to the thrust reverser system 10, since both the power control unit 32 and the FADEC 42 must receive command signals from the throttle 36 in order to operate or reverse thrust via the thrust reverser system 10.

The FADEC 42 may command and control a variety of systems on the aircraft, including the thrust reverser system 10. In some embodiments of the invention, the FADEC 42 may receive lock status information and position information from the position control unit 44, which may receive lock status and position information from the locking devices 22 and position sensors 18. Additionally or alternatively, the FADEC 44 may receive lock status information directly from the locking devices 22 or lock switches 28 associated with the locking devices 22 and/or may command actuation (i.e., locking and unlocking) of the locking devices 22 directly. In some embodiments of the invention, the FADEC 42 may also be configured to provide command signals to the isolation valve 46 and/or the lock valve 48.

The FADEC 42 may also provide various status and fault information to the display processor 38 and/or the status display 40 of the aircraft, notifying the pilot or other control systems of the aircraft of the status of different elements of the thrust reverser system 10 and/or different faults being experienced by the thrust reverser system 10. For example, the FADEC 42 may be configured to compare various status signals and command signals it receives and to determine, based on particular combinations of these status and command signals, if a fault or error has occurred in the thrust reverser system 10. Then the FADEC 42 may transmit this data to the display processor 38 to be processed then displayed on the status display 40 or provided to other control systems of the aircraft.

The position control unit 44 may include one or more processors, logic circuitry, electrical wires, memory, and any combination of hardware and software. The position control unit 44 may be configured to send command signals to receive command signals and power from the power control unit 32 and to send command signals to the servo valves 20 to actuate the actuators 16. Furthermore, the position control unit 44 may receive position information regarding a current or real-time position of the thrust reverser doors 12,14 and/or actuators 16 from the position sensors 18. The position control unit 44 may be configured to use the position information and/or the command signal from the power control unit 32 to determine what commands to send to the servo valves 20.

Furthermore, the position control unit 44 may compare information from a plurality of the position sensors 18 and the commands received from the power control unit 32 to synchronize the actuators 16 by individual adjusting commands provided to at least one of the servo valves 20. Note that keeping the actuators 16 and the thrust reverser doors 12,14 within a same rate of deployment may prevent binding, but loads on the thrust reverser doors 12,14 are not always uniformily distributed. Thus, the present invention actively monitors the position of the thrust reverser doors 12,14 at several locations and/or at each of the actuators 16 via the position sensors 18. The thrust reverser system 10 then utilizes position feedback via the position control unit 44 and/or the FADEC 42 to determine corrective action to be taken by the servo valves 20 to compensate for asymmetric loading and other errors. For example, if asymmetric loading between the actuators 16 causes the position sensors 18 to sense that an upper part of the first thrust reverser door 12 is positioned ahead of or behind a lower part of the first thrust reverser door 12, the position control unit 44 may command corrective action via the servo valves 20. Specifically, the position control unit 44 may command one of the servo valves 20 located at or near the upper or lower part of the first thrust reverser door 12 to increase or decrease the hydraulic flow rate to its corresponding actuator 16 to correct for this asymmetric loading, thereby synchronizing the actuators 16 of the first thrust reverser door 12.

Alternatively, in some embodiments of the invention, functions of the position control unit 44 may be integrated into and/or controlled by the FADEC 42, as illustrate in FIG. 4. For example, the FADEC 42 may be configured to send and command signals, such as electrical control signals, to the servo valves 20 to dictate hydraulic flow rate, pressure, direction, and/or position of corresponding ones of the actuators 16. The FADEC 42 may also be configured to receive real-time or current position information from the position sensors 18 and to use the position information to synchronize actuation of each of the actuators 16 via adjustment of different ones of the servo valves 20.

The isolation valve 46 may be a valve configured to switch on or off depending on commands or signals received from the FADEC 42, the lock valve 48, the throttle 36, the power control unit 32, or any control units of the aircraft. The isolation valve 46 may provide hydraulic fluid or hydraulic pressure to the servo valves 20 and actuators 16 in the “on” position and may prevent hydraulic fluid or pressure from being provided to the servo valves 20 and actuators 16 in the “off” position. In some embodiments of the invention, such as in FIG. 1, the isolation valve 46 may be omitted, depending on the design and configuration of the thrust reverser system 10 and the required levels of redundancy thereof.

The lock valve 48, as illustrated in FIG. 4, may be configured to lock and/or unlock one or more of the locking devices 22 of the thrust reverser system 10. In some embodiments of the invention, the lock valve 48 may be a valve configured to switch on or off (e.g., to switch between commanding the locks to lock or unlock) depending on commands or signals received from the FADEC 42, the isolation valve 46, the throttle 36, the power control unit 32, or any control units of the aircraft. In some embodiments of the invention, such as in FIGS. 1 and 3, the lock valve 48 may be omitted, depending on the design and configuration of the thrust reverser system 10 and the required levels of redundancy thereof. For example, in FIG. 1, some of the locking devices 22 receive command signals directly from the position control unit 44. In FIG. 3, some of the locking devices 22 receive command signals directly from the FADEC 22 and/or the throttle 36.

In some embodiments of the invention, as illustrated in FIG. 2, the lock valve 48 and the isolation valve 46 may be integrated with each other, with a single valve configured to either deny or provide hydraulic fluid or pressure to both the locking devices 22 and the servo valves 20 simultaneously. Again, the integration of any of the FADEC 42, position control unit 44, isolation valve 46, and/or lock valve 48 may depend on the design and configuration of the thrust reverser system 10 and the required levels of redundancy thereof.

As noted above, the thrust reverser system 10 may send and receive various communication, command, fault, and/or status signals to and from the control systems 24 via a network bus, a plurality of discrete communication wires or cables, various wireless communication signals, and/or any means known in the art for transmitting and receiving such signals. Specifically, the thrust reverser system 10 may comprise one or more position status lines 52 configured to transmit position information to and from the position sensors 18, position control unit 44, servo valves 20, user interface 30, and FADEC 42. Furthermore, the thrust reverser system 10 may comprise at least one fault line 54 for delivering fault information to the user interface 30, display processor 38, or other systems of the aircraft. The thrust reverser system 10 may also comprise various lock status lines 56 configured for delivering a status of one or more of the locking devices 22 to the position control unit 44, the user interface 30, the FADEC 42, or other systems of the aircraft. The thrust reverser system 10 may also comprise a plurality of command lines 58 for sending commands from any of the control systems 24 (e.g., the FADEC 42 or the position control unit 44), the power control unit 32, and/or the user interface 30 (e.g., the throttle 36) to each other, to the locking devices 22, and/or to the servo valves 20.

The thrust reverser system 10 may also comprise a plurality of hydraulic supply lines 60 and hydraulic return lines 62 configured for delivering hydraulic fluid from the aircraft hydraulic system 26 to the servo valves 20, actuators 16, and other hydraulically-controlled elements of the thrust reverser system 10. Finally, the thrust reverser system 10 may also comprise one or more power lines 64 configured for providing power to one or more of the control systems 24, servo valves 20, and/or actuators 16.

Specific command and control configurations of the thrust reverser system 10, such as those illustrated in FIGS. 1-4, may be designed for various levels of fault protection to insure that the thrust reverser doors 12,14 do not accidentally deploy or stow at inappropriate or undesired times. In one embodiment of the invention, as illustrated in FIG. 2, command signals from the position control unit 44 to the servo valves 20 cannot work unless the isolation and/or lock valves 46,48 have received a command signal from the FADEC 42 to be actuated to an “on” position, thereby allowing hydraulic fluid to pass to the servo valves 20 and some of the locking devices 22. In another embodiment of the invention, as illustrated in FIG. 3, the locking devices 22 can only unlock if commanded to do so by the FADEC 42, even if the position control unit 44 has been commanded by the power control unit 32 to deploy the thrust reverser doors 12,14. In yet another embodiment of the invention, as illustrated in FIG. 4, the isolation valve 46 must receive a command signal from the throttle 36 directly to turn on and allow hydraulic fluid to pass therethrough, even if the lock valve 48 has received an unlock command signal from the power control unit 32. Conversely, if the isolation valve 46 receives a command signal from the throttle 36, but the lock valve 48 does not receive an unlock command signal from the power control unit 32, the thrust reverser doors 12,14 cannot be deployed in the embodiment of the invention illustrated in FIG. 4.

The thrust reverser system 10 described herein may be used to deploy and stow the thrust reverser doors 12,14 in a controlled, synchronized manner. During hydraulic actuation of the actuators 16, real time position information from the position sensors 18 may be received by one or more of the control systems 24. The control systems 24, such as the position control unit 44 and/or the FADEC 42, may then compare the positions of each of the position sensors 18 to determine if a fault has occurred and/or if any part of the thrust reverser doors 12,14 is lagging behind other portions of the thrust reverser doors 12,14, or if either the thrust reverser doors 12,14 are out of sync with each other. If a fault or lack of synchronization is detected, the position control unit 44 and/or the FADEC 42 may compensate by sending a compensation command signal to independently change hydraulic flow to one or more of the servo valves 20, thereby synchronizing movement of the thrust reverser doors 12,14, as described below.

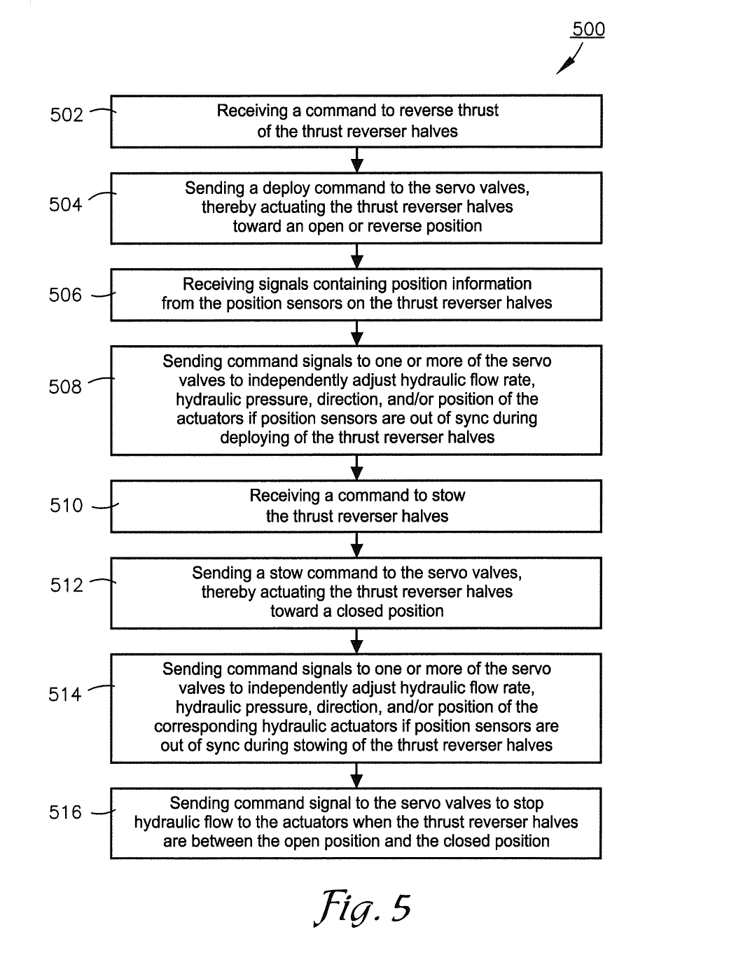

The flow chart of FIG. 5 depicts the steps of an exemplary method 500 for deploying and stowing the thrust reverser doors 12,14. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

As illustrated in FIG. 5, the method 500 may comprise the step of receiving a command with control systems 24 to reverse thrust of the thrust reverser doors 12,14, as depicted in block 502. For example, a pilot may manually actuate the throttle 36 to deploy the thrust reverser doors 12,14. This motion may send a thrust reverse signal (i.e., a command) to the power control unit 32, which may then send a command signal and/or power to the position control unit 44 (as in FIGS. 1-3) or the lock valve 48 (as in FIG. 4). Simultaneously, the actuation of the throttle 36 may cause a thrust command signal to be provided to the FADEC 42. The FADEC 42 may also send the throttle interlock signal 50 to the throttle 36, which may provide tactile feedback to the pilot via the throttle 36 to assist the pilot in determining an extent to which the throttle 36 should be actuated.

The method 500 may also comprise a step of sending a deploy command with the control systems 24 to the servo valves 20, as depicted in block 504, in response to the control systems 24 receiving the thrust reverse command signal. Upon receiving the deploy command, the servo valves may provide hydraulic fluid to the actuators 16, thereby deploying the thrust reverser doors 12,14 toward an open or reverse thrust position. So, when the throttle 36 provides the above-mentioned signals to the FADEC 42 and/or the position control unit 44, the locking devices 22 may be electrically or hydraulically actuated to unlock, and the actuators 16 may be provided with hydraulic flow via command signals provided to the servo valves 20 by the position control unit 44 or the FADEC 42.

Next, the method 500 may comprise a step of receiving signals containing position information with the control systems 24 from the position sensors 18 on the thrust reverser doors 12,14, as depicted in block 506. Then the method 500 may comprise a step of sending command signals, with the control systems 24, to one or more of the servo valves 20 to independently adjust hydraulic flow rate, hydraulic pressure, direction, and/or position of the actuators 16, as depicted in block 508, depending on an amount of offset between the signals received from the position sensors 18.

Specifically, as the actuators 16 are deploying the thrust reverser doors 12,14, the position sensors 18 may continuously or at predetermined intervals send sensed position information to the position control unit 44 and/or the FADEC 42. The position control unit 44 and/or the FADEC 42 may then use the position information for each of the position sensors 18 to determine if a fault has occurred. A fault may be determined to have occurred if one or more of the positions of the position sensors 18 are off or out of sync compared to others of the position sensors 18 by a threshold amount. If a fault occurs, the position control unit 44 or FADEC 42 may determine what corrective action to take and may command the corresponding servo valve or valves 20 accordingly.

For example, if the top position sensor is ahead of the bottom position sensor on one of the thrust reverser doors 12,14 at a given time during deployment, this information may be used by the position control unit 44 to increase hydraulic flow to the bottom actuator until both the top position sensor and the bottom position sensor are in sync with each other. Likewise, if the top and/or bottom position sensors on the first thrust reverser door 12 are out of sync with the top and/or bottom position sensors on the second thrust reverser door 14, actuators 16 of the first and/or second thrust reverser doors 12,14 may be adjusted accordingly by the position control unit 44, which may send signals to some of the servo valves 20 to compensate for the position offsets between the thrust reverser doors 12,14. The position control unit 44 may use a plurality of software and hardware functions to calculate an appropriate amount of compensation required based on the feedback provided by the position sensors 18 and predetermined thresholds stored in a memory accessible by the position control unit 44. For example, if the top and bottom position sensors are out of sync by greater than a threshold amount, the speed of one of the corresponding actuators 16 can be increased via command signals sent to the corresponding servo valves 20. However, this increase in speed may also depend on threshold maximum speeds allowed for the actuators 16 and other various design and operational constraints built into or programmed into the position control unit 44.

In some embodiments of the invention, the method 500 may further comprise steps for stowing the thrust reverser doors 12,14. Specifically, the method 500 may comprise the steps of receiving a command with the control systems 24 to stow the thrust reverser doors 12,14, as in block 510, and sending a stow command, with the control systems 24, to the servo valves 20, as depicted in block 512. When receiving the stow command, the servo valves 20 may each reverse the flow of hydraulic fluid to the hydraulic actuators 16, thereby actuating the thrust reverser doors 12,14 toward a closed position. Next, the method 500 may comprise sending command signals to one or more of the servo valves 20 to independently adjust the hydraulic flow rate, hydraulic pressure, direction, and/or position of the corresponding hydraulic actuators 16, as depicted in block 514, depending on an amount of offset between the signals received from the position sensors 18 as the thrust reverser doors 12,14 are actuated toward the closed position. Optionally, the method 500 may include a step of sending a command signal to the servo valves 20 to stop hydraulic flow to the hydraulic actuators 16 at a point when the thrust reverser doors 12,14 are between the open position and the closed position, as depicted in block 516.

Advantageously, the present invention makes use of servo controlled hydraulic actuators to provide thrust reverser actuation and synchronization without the use of mechanical synchronization shafts, gears, bearings, and drive nuts. Synchronization between thrust reverser doors 12,14 of the present invention can be achieved without the typical cross-over drive shaft and/or lower synchronization latches of prior art systems. Furthermore, the hydraulic servo control architecture of the present invention allows varied thrust levels at uniform engine power levels. Conversely, prior art thrust reverser systems are limited to either fully open or closed positioning where the amount of reverse thrust power is proportional to engine thrust level settings. Furthermore, typical spool down and spool up times required for open/closed transition can be eliminated by controlled opening and closing rates, as provided by the present invention.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A thrust reverser system comprising:
a thrust reverser door configured to be actuated between an open position and a closed position relative to a nacelle of an aircraft;
a hydraulic actuator attached to the thrust reverser door and configured to actuate the thrust reverser door between the open position and the closed position;
a servo valve communicatively coupled with the hydraulic actuator and configured to control hydraulic flow to and from the hydraulic actuator;
a position sensor configured to provide signals associated with a position of the thrust reverser door; and
a control system configured to receive the signals from the position sensor and send command signals to the servo valve depending on the signals received from the position sensor.

2. The thrust reverser system of claim 1, wherein the control system is configured to determine any differences between the signals received by the position sensor and to command the servo valve to adjust at least one of hydraulic flow rate, hydraulic pressure, direction, and position of the hydraulic actuator based on the differences determined.

3. The thrust reverser system of claim 2, comprising a first thrust reverser door and a second thrust reverser door; a first hydraulic actuator coupled with the first thrust reverser door and a second hydraulic actuator coupled with the second thrust reverser door; and a first position sensor attached to the first thrust reverser door and a second position sensor attached to the second thrust reverser door.

4. The thrust reverser system of claim 3, wherein the first and second position sensors are linear variable differential transformer (LVDTs).

5. The thrust reverser system of claim 1, wherein the thrust reverser door is a translatable cowl of an aircraft nacelle thrust reverser.

6. The thrust reverser system of claim 1, wherein the servo valve is configured to provide continuously variable speed and position control of the hydraulic actuator for the thrust reverser door.

7. The thrust reverser system of claim 1, wherein the control system comprises at least one of a full authority digital engine control (FADEC) and a position control system configured to receive commands from controls in a cockpit of the aircraft.

8. The thrust reverser system of claim 7, further comprising at least one locking device configured to lock the thrust reverser door at a particular position based on commands received from the control system.

9. The thrust reverser system of claim 8, wherein the control system further comprises at least one of a lock valve configured to provide hydraulic flow to lock or unlock the locking device and an isolation valve configured to turn hydraulic flow to and from the servo valve and actuator on or off.

10. A thrust reverser system comprising:
a first thrust reverser door configured to be actuated between an open position and a closed position relative to a nacelle of an aircraft;
a second thrust reverser door configured to be actuated between an open position and a closed position relative to a nacelle of an aircraft;
at least two hydraulic actuators attached to each of the thrust reverser doors and configured to actuate the thrust reverser doors between the open position and the closed position;
a plurality of servo valves, wherein each of the servo valves is communicatively coupled with one of the hydraulic actuators and configured to control hydraulic flow to and from the hydraulic actuators;
at least two position sensors mounted on each of the thrust reverser doors and configured to provide signals associated with a position thereof; and
a control system configured to receive the signals from the position sensors and send command signals to the servo valves depending on an amount of offset between the signals received from the position sensors.

11. The thrust reverser system of claim 10, wherein the control system is configured to calculate differences between the signals received by the position sensors and to command at least one of the servo valves to adjust at least one of hydraulic flow rate, hydraulic pressure, direction, and position of at least one of the hydraulic actuators based on the calculated differences.

12. The thrust reverser system of claim 10, wherein the position sensors are linear variable differential transformer (LVDTs).

13. The thrust reverser system of claim 10, wherein the thrust reverser doors each comprise a translatable cowl of an aircraft nacelle thrust reverser.

14. The thrust reverser system of claim 10, wherein the servo valves are configured to provide continuously variable speed and position control of the hydraulic actuators for the first and second thrust reverser doors.

15. The thrust reverser system of claim 10, wherein the control system comprises at least one of a full authority digital engine control (FADEC) and a position control system, wherein at least one of the FADEC and the position control system is configured to receive commands from controls in a cockpit of the aircraft, configured to receive feedback from the position sensors, and configured to send command signals to the servo valves in response to feedback from the position sensors.

16. The thrust reverser system of claim 15, further comprising at least one locking device associated with each of the first and second thrust reverser doors and configured to lock the thrust reverser doors at particular positions based on commands received from the control system.

17. The thrust reverser system of claim 16, wherein the control system further comprises at least one of a solenoid lock valve configured to provide hydraulic flow to lock or unlock the locking device and a solenoid isolation valve configured to turn hydraulic flow to and from the servo valves and actuators on or off.

18. A method of actuating thrust reverser doors of a thrust reverser system, the method comprising:
receiving a command with a control system to reverse thrust of at least one of the thrust reverser doors;
sending a deploy command with the control system to at least two servo valves, wherein, when receiving the deploy command, the at least two servo valves are each configured to provide hydraulic fluid to one of a plurality of hydraulic actuators attached to at least one of the thrust reverser doors, thereby deploying the at least one of the thrust reverser doors toward an open or reverse thrust position;
receiving signals containing position information with the control system from at least two position sensors mounted on at least one of the thrust reverser doors; and
sending command signals with the control system to at least one of the servo valves to adjust at least one of hydraulic flow rate, hydraulic pressure, direction, and position of at least one of the hydraulic actuators depending on an amount of offset between the signals received from the position sensors.

19. The method of claim 18, further comprising:
receiving a command with the control system to stow at least one of the thrust reverser doors;
sending a stow command with the control system to the at least two servo valves, wherein, when receiving the stow command, the at least two servo valves are each configured to reverse the flow of hydraulic fluid to one of the plurality of hydraulic actuators, thereby actuating the at least one of the thrust reverser doors toward a closed position; and
sending command signals to at least one of the servo valves to adjust at least one of hydraulic flow rate, hydraulic pressure, direction, and position of at least one of the hydraulic actuators depending on an amount of offset between the signals received from the position sensors as the at least one of the thrust reverser doors is actuated toward the closed position.

20. The method of claim 19, further comprising sending a command signal to the servo valves to stop hydraulic flow to the hydraulic actuators at a point when the at least one of the thrust reverser doors is between the open position and the closed position.
